(19) United States
(12) Patent Application Publication
(10) Pub. No.: US 2008/0033986 A1
(43) Pub. Date: Feb. 7, 2008

(54) SEARCH ENGINE FOR AUDIO DATA

(75) Inventors: James V. McCusker, Warrington, PA (US); Timothy B. Regovich, Moorestown, NJ (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: PHONETIC SEARCH, INC., King of Prussia, PA (US)

(21) Appl. No.: 11/774,655

(22) Filed: Jul. 9, 2007

Related U.S. Application Data
(60) Provisional application No. 60/819,181, filed on Jul. 7, 2006.

(51) Int. Cl. G06F 12/06; G06F 17/30; G06F 3/048; G06F 7/06

(52) U.S. Cl. 707/102; 707/2; 707/5; 709/203; 715/764; 707/E17.008; 707/E17.017; 707/E17.107

(57) ABSTRACT

Audio streams are captured and simultaneously indexed in real time from a plurality of audio sources. The captured audio streams and index data of the captured audio streams from the plurality of audio sources are then stored. The storing process operates by temporarily storing the most recently captured audio streams, temporarily storing index data of the most recently captured audio streams, and then periodically loading the temporarily stored audio streams into permanently stored audio streams and periodically loading the temporarily stored index data into the permanently stored index data. A search and media distribution system is connected to the temporarily stored audio streams and the temporarily stored index data for allowing real time search and retrieval access to the captured audio streams.

### CROSS REFERENCE TO RELATED APPLICATION

This application claims the benefit of U.S. Provisional Patent Application No. 60/819,181 filed Jul. 7, 2006.

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

The conventional approach to indexing media content typically occurs during a post production process. Media is recorded and stored before it is indexed. This process introduces latency proportional to the duration of the stored media plus the time required to encode, store and index. While this latency can be reduced by shortening the media duration, the proportional latency will still persist. Also, reducing media recordings to smaller ‘chunks’ can introduce inefficiencies into various indexing technologies which tend to work better with longer durations of media. For instance, speech-to-text transcription technologies tend to work best when they have enough audio so the transcriber can perform predictive analysis based on grammar and word paring rules.

It is desirable to provide a real time indexing and search process for audio data. The present invention fulfills that need.

### BRIEF SUMMARY OF THE INVENTION

Audio streams are captured and simultaneously indexed in real time from a plurality of audio sources. The captured audio streams and index data of the captured audio streams from the plurality of audio sources are then stored. The storing process operates by temporarily storing the most recently captured audio streams, temporarily storing index data of the most recently captured audio streams, and then periodically loading the temporarily stored audio streams into permanently stored audio streams and periodically loading the temporarily stored index data into the permanently stored index data. A search and media distribution system is connected to the temporarily stored audio streams and the temporarily stored index data for allowing real time search and retrieval access to the captured audio streams.

### BRIEF DESCRIPTION OF THE DRAWINGS

The above summary, as well as the following detailed description of preferred embodiments of the invention, will be better understood when read in conjunction with the following drawings. For the purpose of illustrating the invention, there is shown in the drawings an embodiment that is presently preferred, and an example of how the invention is used in a real-world project. It should be understood that the invention is not limited to the precise arrangements and instrumentalities shown. In the drawings:

FIG. 1 is an overview schematic block diagram of an audio data capture and search system in accordance with one preferred embodiment of the present invention.

FIG. 2 is a combination schematic block diagram and flowchart related to the capture and index process of the system of FIG. 1 in accordance with one preferred embodiment of the present invention.

FIG. 3 is a sample database schema for the system of FIG. 1 in accordance with one preferred embodiment of the present invention.

FIGS. 4-7 show sample user interface display screens for one preferred embodiment of the present invention.

FIG. 8 is a combination schematic block diagram and flowchart that shows the relationship between system modules in accordance with one preferred embodiment of the present invention.

FIGS. 9A and 9B show sample sets of search results in accordance with one preferred embodiment of the present invention.

FIG. 10 shows a sample output search result set in accordance with one preferred embodiment of the present invention.

FIG. 11 shows a sample article for illustrating category taxonomy in accordance with one preferred embodiment of the present invention.

FIG. 12 shows how a sample article would be rated based on category taxonomy in accordance with one preferred embodiment of the present invention.

FIG. 13 is a flowchart of a real time index process in accordance with one preferred embodiment of the present invention.

FIG. 14 is a flowchart of a real time search process in accordance with one preferred embodiment of the present invention.

FIG. 15 is a combination schematic block diagram and flowchart that shows the relationship between system modules in accordance with another preferred embodiment of the present invention.

FIG. 16 is an overview schematic block diagram of an audio data capture and search system in accordance with another preferred embodiment of the present invention.

FIG. 17 is a flowchart of a process for using time information to improve media search results in accordance with one preferred embodiment of the present invention.

FIGS. 18A-18C show user interface display screens for conducting a search in accordance with one preferred embodiment of the present invention.

FIG. 19 is a flowchart of a search algorithm that uses category taxonomies to rank search results in accordance with one preferred embodiment of the present invention.

FIG. 20 is a schematic block diagram of the hardware elements for implementing the search process of FIG. 19 in accordance with one preferred embodiment of the present invention.

FIG. 21 shows a lookup table for using a key to identify media sources and starting points in accordance with one preferred embodiment of the present invention.

### DETAILED DESCRIPTION OF THE INVENTION

This patent application includes an Appendix having a file named appendix.txt, created on Jul. 3, 2007, and having a size of 208,263 bytes. The Appendix is incorporated by reference into the present patent application.

Certain terminology is used herein for convenience only and is not to be taken as a limitation on the present invention.

I. Capture and Search of Audio Data

### A. Scenario 1

A first embodiment of the present invention provides a system for continuous capture and processing of multiple media sources for the purpose of enabling the searching of spoken content of media sources. A user can search for spoken content using phonetic and text indexes. The system further provides the ability to play back media search results at the specific time offset where the spoken content was found, and the ability to extract media clips from search results. The system has the ability to search multiple media sources simultaneously over a period of one or more days and hours within each day.

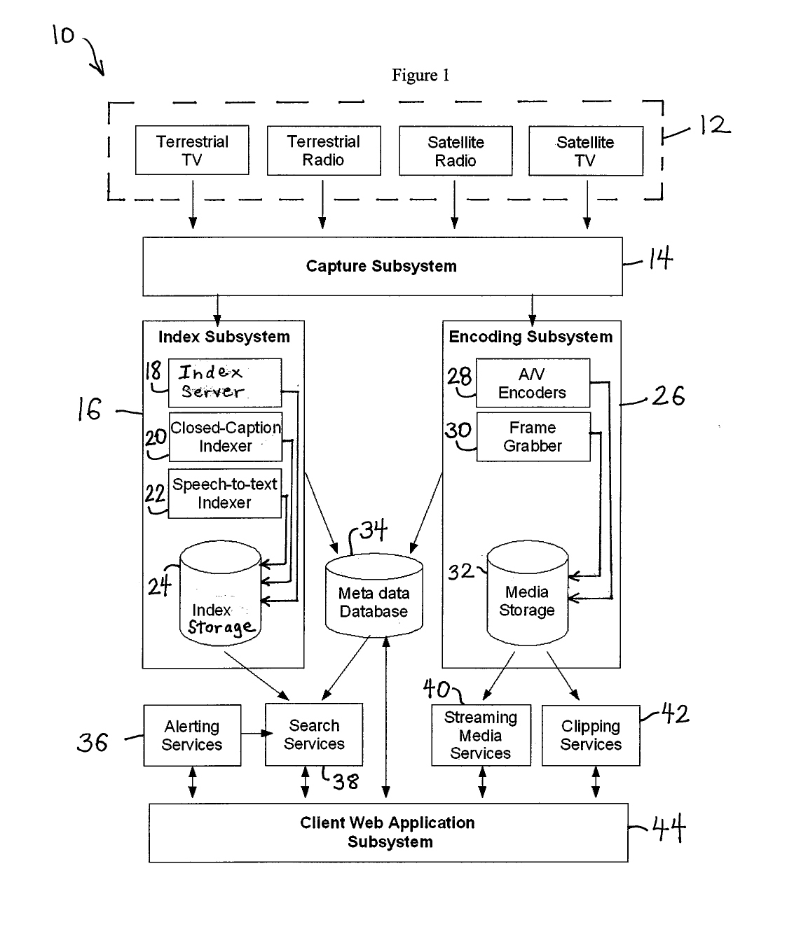

FIG. 1 is an overview schematic block diagram of the system 10. The system 10 is comprised of the following components:
1. Media sources 12, such as terrestrial television and radio broadcast, satellite radio and television, or Internet media content;
2. Capture subsystem 14 including one or more devices capable of capturing audio/video from various source inputs;
3. Index subsystem 16 including an index server 18, closed-captioning text indexer 20, speech-to-text indexer 22, and index storage 24;
4. Encoding subsystem 26 including A/V encoder(s) 28 (e.g., Windows Media, Real Networks, QuickTime, Flash, etc), video frame grabber(s) 30, and media storage 32;
5. Metadata database subsystem 34 used to store metadata related to media files, indexes, frame grabs, and application data;
6. Alerting services 36 that provide automatic searches of newly indexed media;
7. Search services 38 that perform media searches using one or more of the media indexes;
8. Streaming media services 40 to stream media content to clients requesting play back of media content;
9. Clipping Services 42 to provide media extraction of media clips from media storage;
10. Client web application subsystem 44 providing users with access to search, play back and clipping services.

Additional details of certain components are provided below:

Capture subsystem 14: Digitally encodes audio or audio/video data from a receiving device (e.g., radio tuner, CATV demodulator, Satellite TV receiver, Satellite Radio receiver) and stores the data in one or more common digital encoding formats (e.g., PCM, WMA, WMV, Real, Flash, DivX). One suitable capture system for audio/video is a standard personal computer (PC) running Windows XP, Windows Media Encoder 9, and an Osprey 440 audio/video capture card available from ViewCast Corporation, Plano, Tex. One preferred embodiment of this system would utilize the CaptureTool.exe module in the source code Appendix.

Index Subsystem 16: Performs the task of encoding the audio portion of the digitally captured content into a phonetic index stream which represents the detected phonetic utterances detected in the digital audio. In one preferred embodiment of the present invention, one suitable index subsystem is a conventional PC running Windows XP and the AxIndex.exe module in the source code Appendix.

Metadata database 34: Maintains various system tables that track the status of the media that is being ingested and indexed by the Capture Subsystem 14 and the Index Subsystem 16. One suitable database system is a conventional PC running Windows Server 2003 and MySQL 4.x database server.

Index Storage 24—Storage system that holds the phonetic index files that are generated by the Index Subsystem 16. One suitable index storage system is a conventional PC running Windows Server 2003 setup as a file server.

Media Storage in the Encoding Subsystem 26: Storage system that holds the digitized media files that are generated by the Capture Subsystem 14. One suitable media storage system is a conventional PC running Windows Server 2003 setup as a file server. In one preferred embodiment of the present invention, this system would utilize the Clipper.exe module in the source code Appendix.

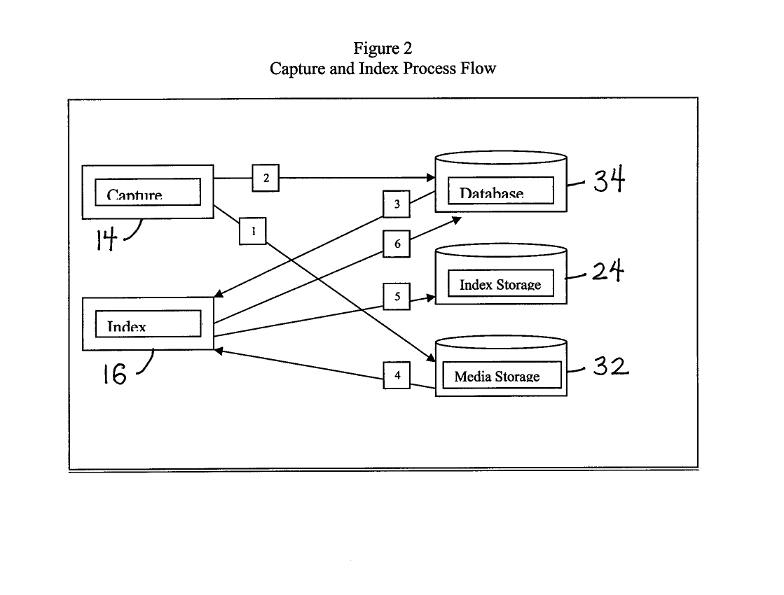

FIG. 2 is a combination schematic block diagram and flowchart related to the capture and index process. The process flow steps in FIG. 2 are described as follows, wherein the step numbers correspond with the numbers in FIG. 2:
(1) The Capture subsystem 14 digitally captures audio or audio/video sources and stores the encoded media to the Media Storage 32 in a series of file chunks that represent a specific period of time (e.g., 1 hour, 30 minutes, 5 minutes).
(2) Once a unit of content is completed, the Capture subsystem 14 generates a new “recording record” in the database 34 that identifies the new contents metadata, including file location, duration, recording start time and status. The status is set to indicate that the content is new and has not been indexed.
(3) The Index server 18 in the Index subsystem 16 periodically polls the database 34 for new content that has not been indexed. This step continues to step 4 once a record is found indicating a media file that requires indexing. In an alternative embodiment, instead of polling the database, the index server 18 may also receive “events” that trigger it to initiate indexing.
(4) The Index server 18 reads the media file from the Media Storage 32 and processes the digital media using a phonetic indexing algorithm.
(5) The Index server 18 writes the phonetic index file to the Index storage 24. Steps 4 and 5 continue until the entire media file has been indexed.
(6) The “recording record” for the media file is updated to indicate that the media file has been indexed. This record is also updated to indicate the location of the index file that was stored on the Index storage system.

The system described above can be implemented using many different hardware and software platforms. Technical details of some suitable platforms for performing the above-described functions are provided below.
1. Media Capture: This component ingests audio and video media from terrestrial antenna, satellite receiver, cable converter, or streaming source. Signals are typically captured using multiport audio and video capture cards that are deployed in rack-mounted server-class hardware (eg. Dell 2850, 2 GB, RAID 1). Once content is captured, it is moved to storage server(s).
2. Media Indexing: Media Indexing is performed using the Aurix Audio Miner, available from Aurix Limited, United Kingdom. Indexing jobs are assigned across multiple blade servers. Hardware includes multiple Dell 1855 blade servers (Dual Xeon, 1 GB RAM).
3. Database: MySQL 4.x is deployed on a Dell 1855 Dual XEON system with 2 GB RAM. The database is easily portable to MS SQL Server or Oracle if architecture dictates the need.
4. Storage: Storage capacity of 1.2 TB is sufficient based on a load of saving for 45 days or 8,640 hours of content. Storage can be scaled based on the number of media channels being captured and indexed, and customer demand for search access. Multiple high storage solutions such as iSCSI (Internet small computer system interface) or SAN (Storage Area Network) can be used depending upon architectural requirements.
5. Search: In one implementation, a single Search Server leverages the Aurix Audio Miner API through a multi-threaded service. The system is deployed on a Dell 1855 Dual XEON server with 1 GB RAM. This architecture allows for the deployment of multiple search servers that will handle the load in parallel. Each search service executes up to four separate threads of searching in order to optimize processor loading. Search jobs are handled in a FIFO pipeline and leverage Microsoft Message Queuing (MSMQ) technology for asynchronous job scheduling and management.
6. Streaming Media: In one implementation, the system leverages Microsoft Media Server Enterprise deployed on a Dell 1855 blade server. Additional media servers can be added based on demand and deployed using load balancing hardware/software as demand increases.
7. Web: All web applications may be deployed as ASP.Net (1.1) applications running on a Dell 1855 Dual XEON blade server with 1 GB RAM. Additional web servers can be added on demand and deployed using load balancing hardware/software as demand increases.

The embodiment of the present invention described herein captures at least 12 unique signals, including four terrestrial radio signals, one satellite radio signal, three cable television networks and four local television stations, 100 daily hours of radio, and 92 daily hours of television. The operating system of this embodiment is physically hosted at SNIP (www.snip.net), which is an Internet Service Provider (ISP) and Competitive Local Exchange Carrier (CLEC). SNIP's backbone to the Internet consists of two OC3 (155 Mbs) connecting through UUNet and Sprint.

Regarding scalability, for television, the system scales at a rate of 1 capture and 1 indexer for every 96 hours of daily television content (4 channels 24/7). For radio, the system scales at a rate of 1 capture and 1 indexer for every 192 hours of content (8 stations 24/7).

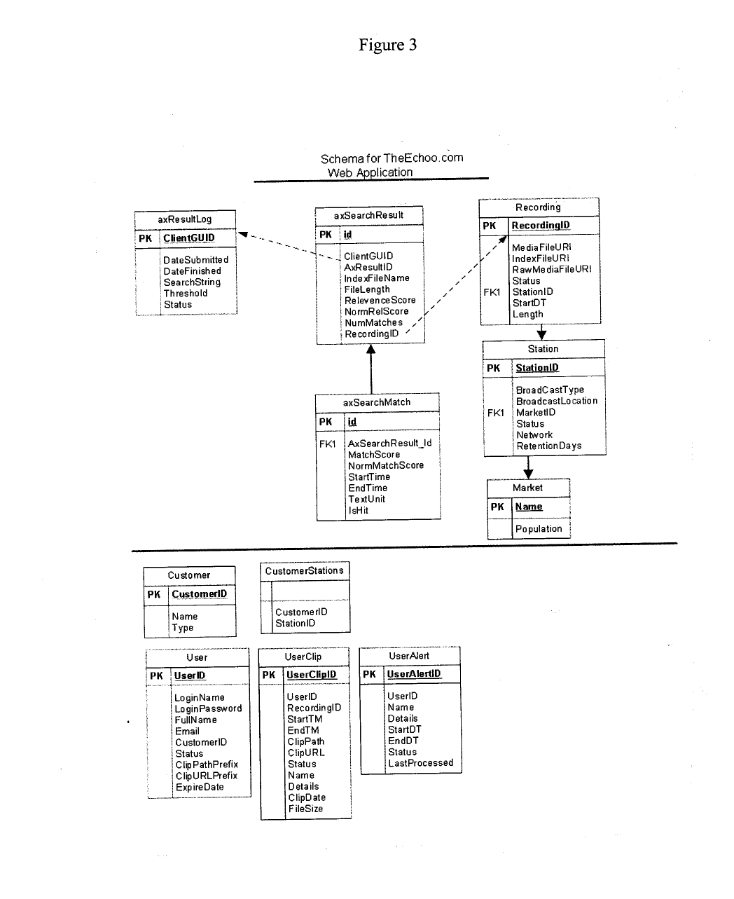

FIG. 3 shows a self-explanatory sample database schema for one preferred embodiment of the present invention described herein.

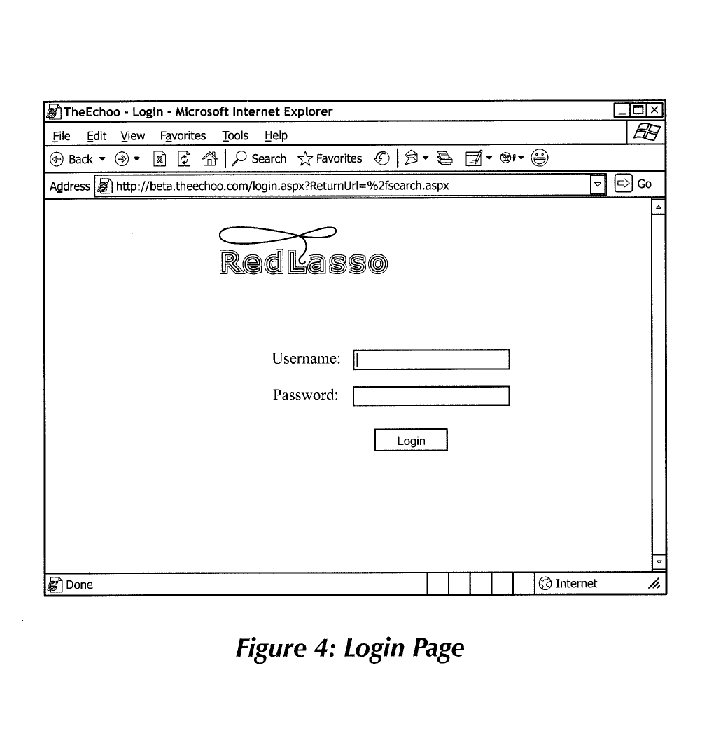

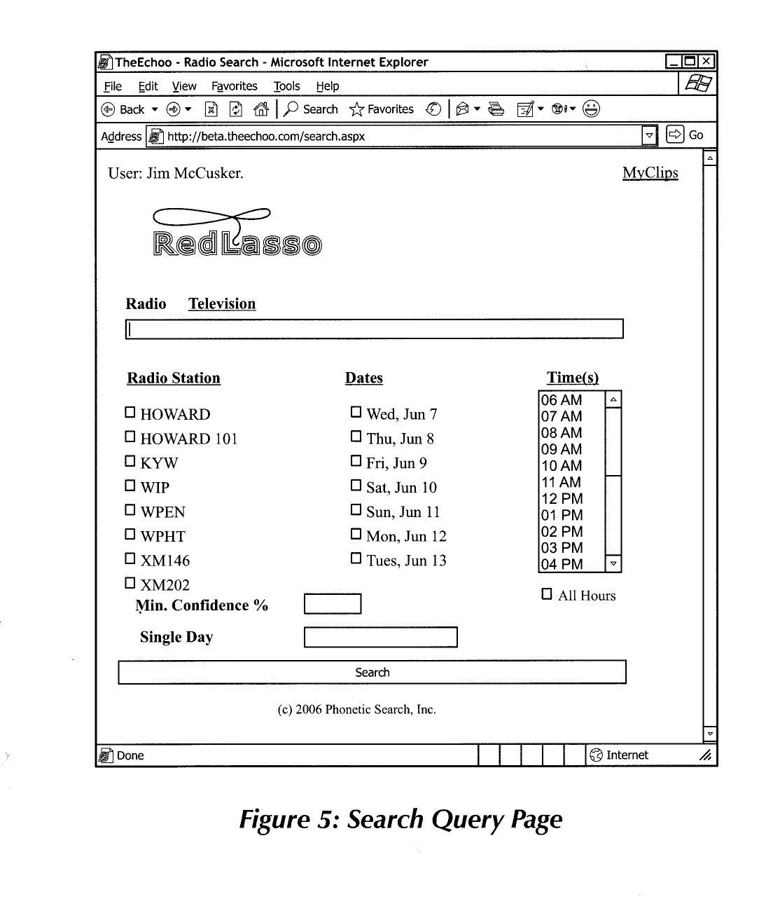

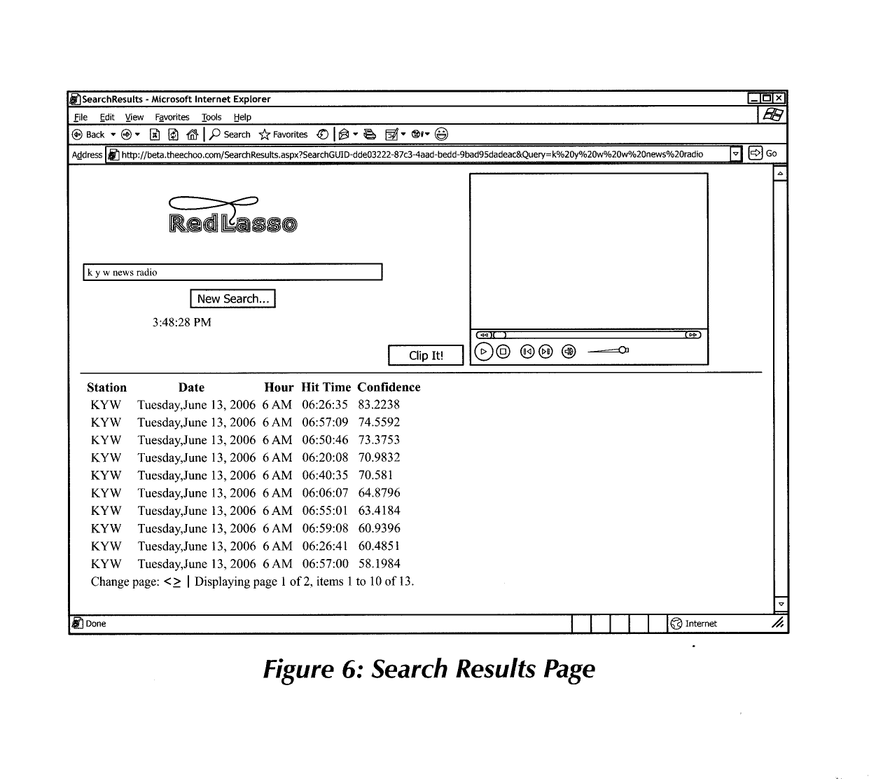

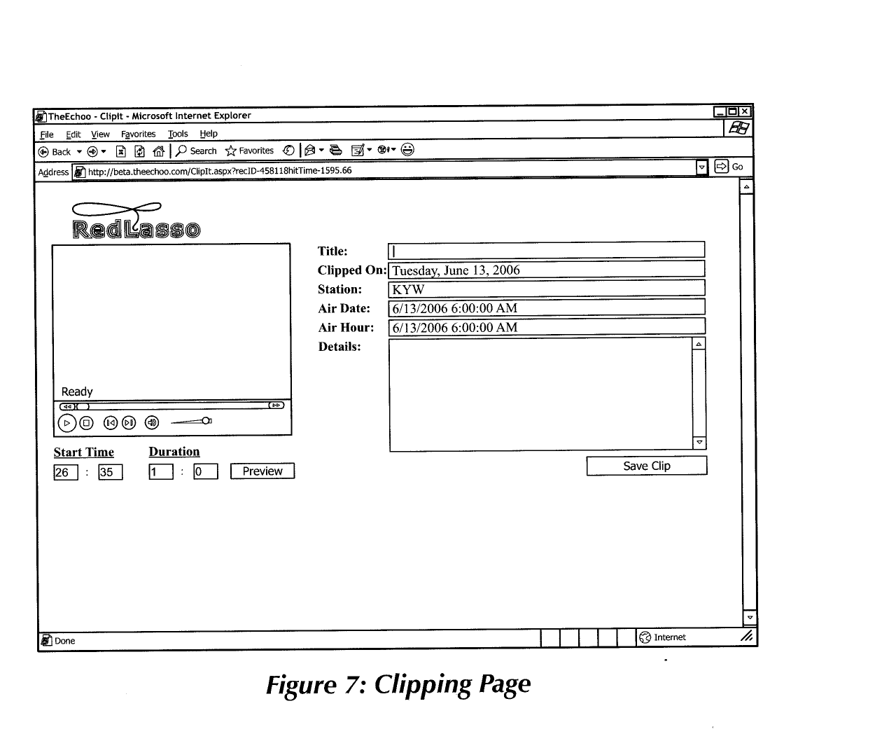

FIGS. 4-7 show sample display screens for one preferred embodiment of the present invention described herein. FIG. 4 shows a user login page. FIG. 5 shows a search query page. In this example, the user is searching for the audio phrase “k y w news radio.” FIG. 6 shows a search results page that shows 10 of the 13 identified hits (items). FIG. 7 shows a clipping page. On the clipping page, a user can listen to/watch selected portions of the actual audio broadcast identified by the search. In this example, item 1 of the hit list is being played.

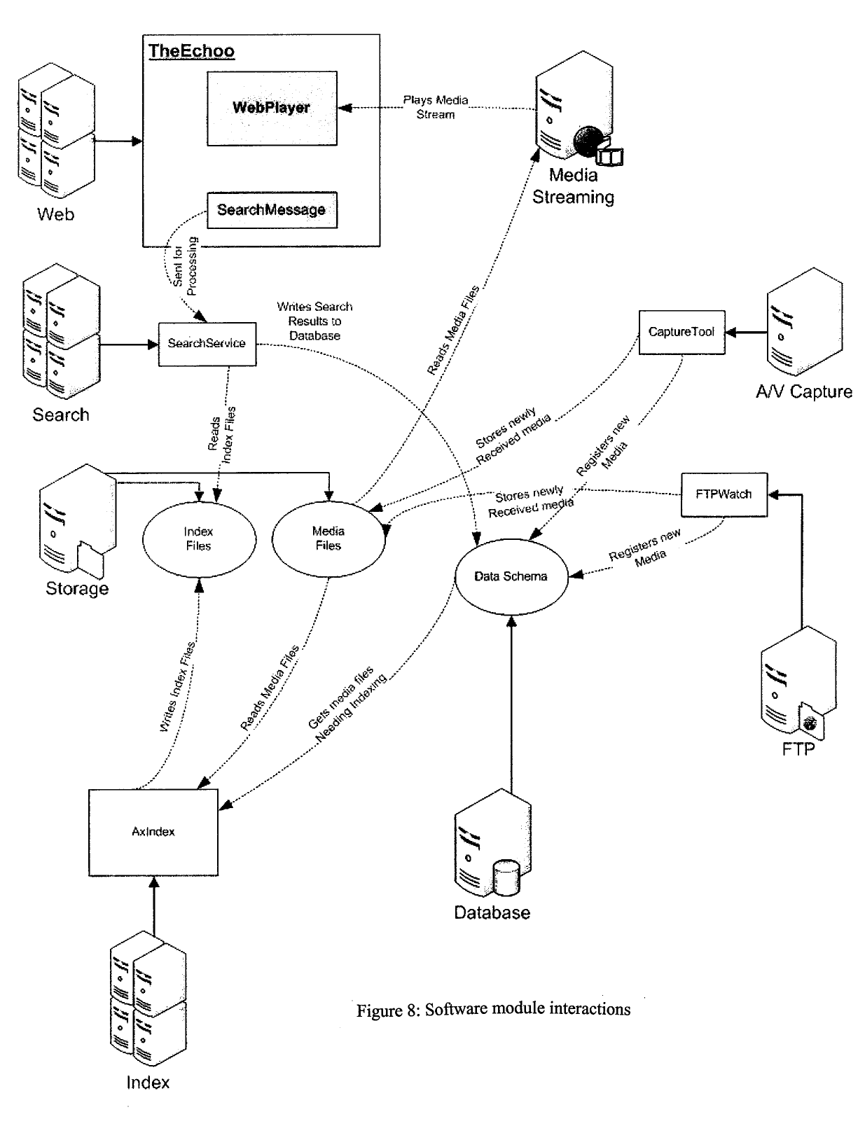

FIG. 8 is a self-explanatory drawing that shows the relationship between each of the system modules. For clarity, an icon is provided for each server in the system that the module is associated with.

### B. Scenario 2

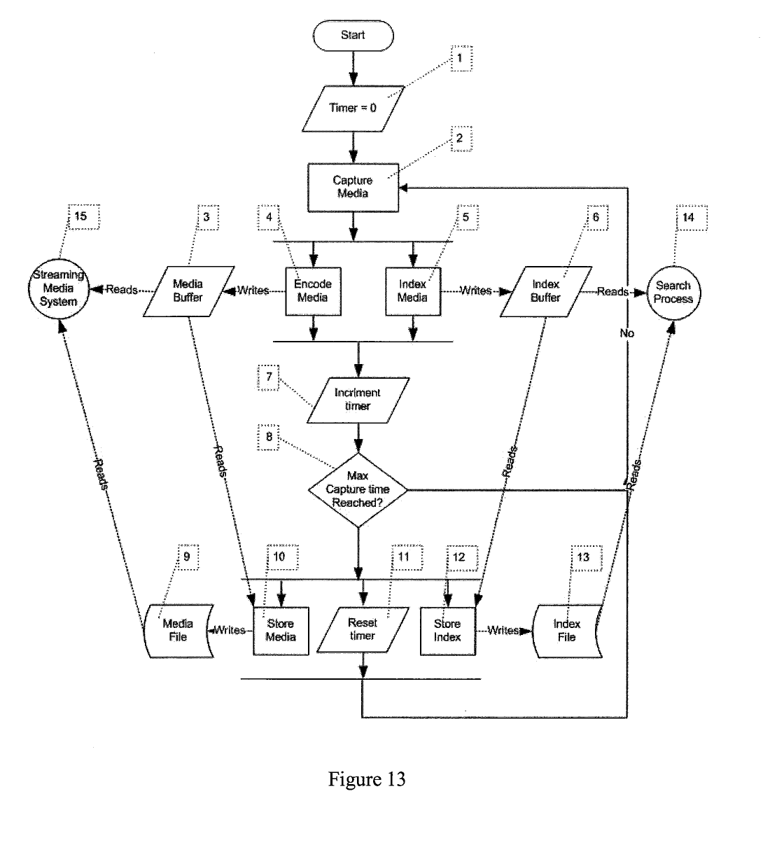

In an alternative scenario, FIG. 13 is a flowchart of a real time index process that continuously captures, encodes and indexes media for a period of time. Once the predefined amount of time has elapsed, the encoded and indexed media is stored into permanent storage. The process begins by resetting a timer counter to zero (1) and then beginning a media capture process (2). The media capture process is capable of capturing audio, video or audio and video simultaneously. The media capture process produces one or more streams of data that are forked to two processing units, Encode Media (4) and Index Media (5). The Index Media process writes the indexed data (e.g., phonetic index, text transcription, and/or metadata derived from the audio or video data stream) to an index buffer (6). The Encode Media process writes the encoded media (e.g., MP3, FLV, WMA, WMV) to a media buffer (3). The media and index buffers (3,6) are shared storage areas that are available to other system processes, such as the search system (14) and the streaming media system (15). The system tracks the passage of time (7). As long as the time is below the predefined capture time, the system continues capturing (2). Once the time reaches or exceeds a predetermined time interval, the system forks three processes; Store Media (10) which reads encoded media data from the media buffer (3) and writes the data to a permanent media file (9), Store Index (12) which reads index data from the index buffer (6) and writes the data to a permanent index file (13), and resetting of the timer (11). The media and index storing processes run asynchronously, thereby allowing the capture process to continue without interruption.

Instead of using a timer, the buffering process may be controlled by an amount of captured data bytes. In this process, a byte counter replaces the timer and the byte counter is incremented and reset in the same manner as the timer.

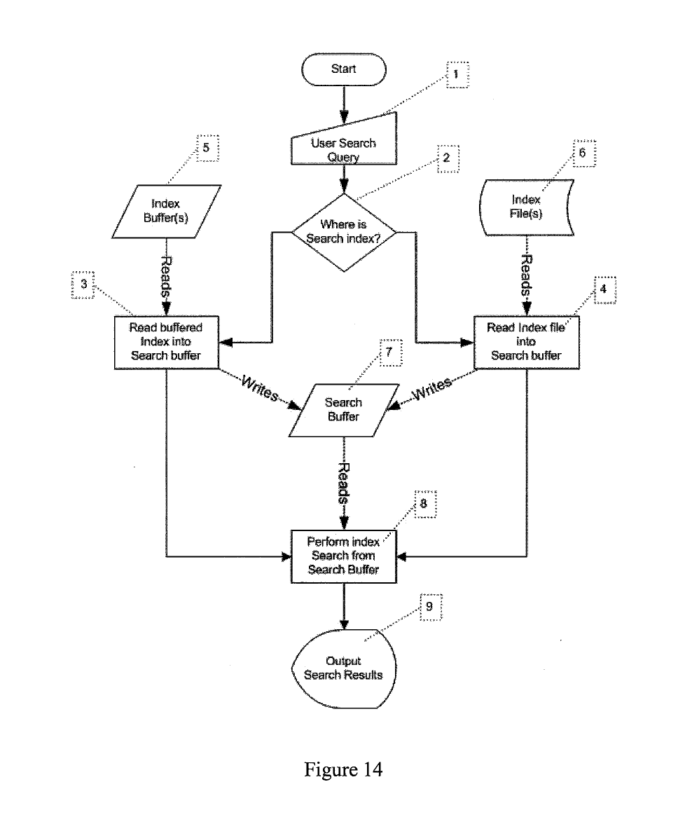

FIG. 14 is a flowchart of a real time search process related to the indexing process in FIG. 13. This process has read access to the Index buffers (5) and Index files (6) referenced in FIG. 13 as Media Buffer (3) and Index Buffer (6). FIG. 14 shows the search process that is capable of using both the buffered index (5) and the stored index files (6). The search process starts with a user inputted search query (1). The search system makes a determination of which index to search (2). If the index is still in the Index buffer (5), a process is executed (3) to read the buffered index data into the search buffer (7). If the index is in permanent storage, a process is executed (4) to read the index file data into the search buffer (7). Once all index data is written to the search buffer, a process (8) is executed to search the search buffer (7). The results of the search are then returned for output (9) to the user.

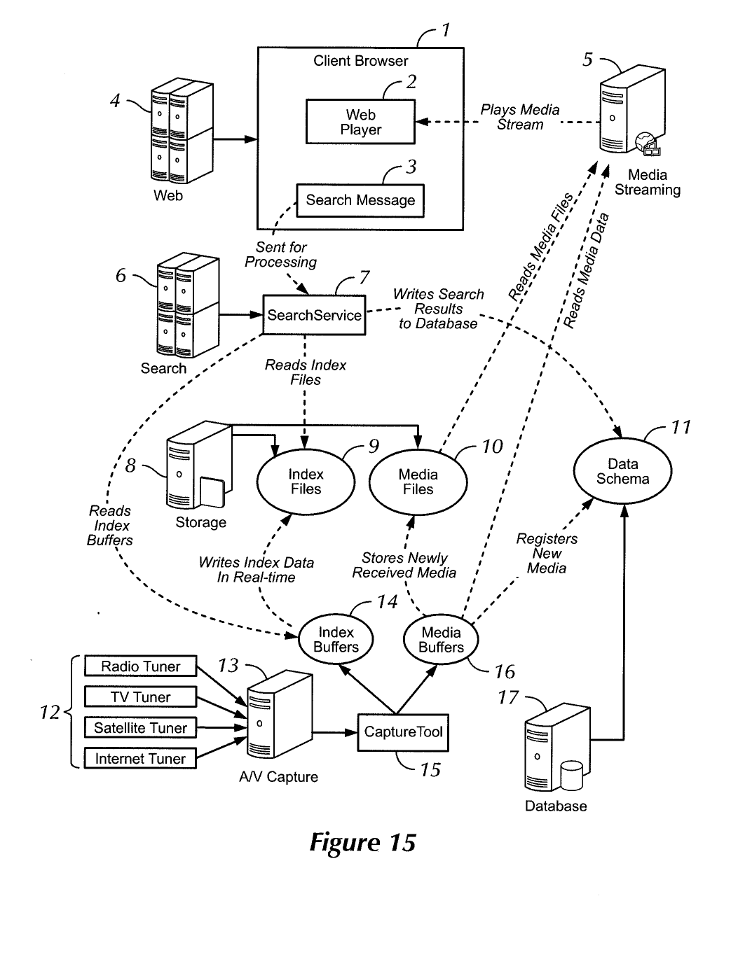

FIG. 15 shows an audio data capture and search system that allows for searching of media in real time. The system is comprised of a plurality of audio and audio/video inputs (12) which can originate from a multitude of sources including terrestrial broadcast radio and/or television (TV); satellite radio and/or TV; live internet media streams; or direct audio inputs to an a/v capture system (13). Each media source can be captured using various commercially available receivers, a/v capture hardware and internet stream capture products. The a/v Capture system (13) enables the real time capture of such audio and audio/video and encoding of the media into a digital stream. The digital stream is then distributed to a plurality of processing software processes (shown as CaptureTool (15) in FIG. 15) that are capable of indexing, encoding and storing of the media (10) and index (9) data in real time. One suitable a/v capture system (13) comprises a Dell 2850 dual Xeon system with 2GB RAM running Windows XP. The capture system includes an a/v capture card (e.g., ViewCast Osprey 440, commercially available from ViewCast Corporation, Plano, Tex.). The CaptureTool writes encoded media to the media buffers (16) and the index data to the index buffers (14). The CaptureTool (15) also acts as an archiver by writing the index buffers and media buffers to permanent storage (8) at predefined intervals. The storage system (8) consists of one or more file servers (e.g., Dell 2850 with five 360GB RAID-5 drives for storage, Windows Server 2003). The CaptureTool (15) stores the captured media and index data to a file share organized into a logical folder hierarchy for efficient storage of the data. The CaptureTool (15) updates the database (11) as new media and indexes are written to permanent storage. The database (11) can be implemented using common database systems such as SQL Server, Oracle and MySQL. The database server (17) can be deployed using a Dell 2850 system (e.g., dual Xeon, 2 GB Ram, 300 GB HDD). The Search System (6) consists of one or more systems (e.g., Dell 1850, Xeon, 1 GB RAM, 36 GB HDD) where the Search Service (7) serves search requests from the Web site servers (4). The Web site servers (4) are responsible for gathering search requests from clients (1), typically through a web browser interface. A client search request (SearchMessage (3)) is sent to a Search Service (7) for processing. The results of the search are returned to the client (e.g., Client Browser (1)) as links to the associated media that are accessed through the use of a Media Streaming (5) server (e.g., Windows Media Services or Flash Media Services).

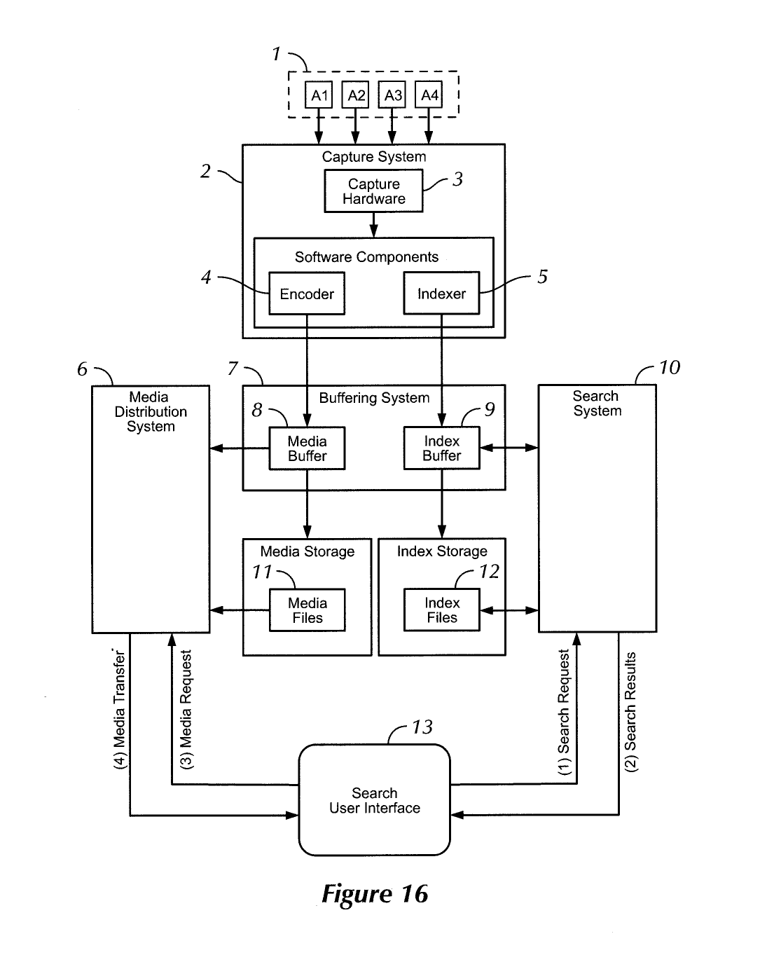

FIG. 16 further demonstrates how a search system may be constructed to allow the searching of the media streams in real time. The buffering system (7) enables the system to search media indexes in real time by allowing the search system (10) access to an index buffer (9). The index buffer (9) operates as a staging area where new index data is written by the indexer (5) system while also providing read access to the search system (10). At some predetermined interval (e.g., time, number of bytes), a new index buffer (9) is initialized and the prior index buffer (9) is transferred to the index storage system (12). Once the index buffer (9) is transferred to the index storage system (12), the search system (10) can utilize the newly created index located in the index storage system (12), as well as any new index data in the index buffer (9). The elements in FIG. 16 are labeled as follows:
1—media sources
2—capture system
3—capture hardware
4—encoder
5—indexer
6—media distribution system
7—buffering system
8—media buffer
9—index buffer
10—search system
11—media files
12—index files
13—search user interface

In one preferred implementation of the buffering system, the media buffer and the index buffer are ring buffers (also, known as “circular buffers”). A ring buffer is a data structure that uses a single, fixed-size buffer as if it were connected end-to-end. This structure lends itself easily to buffering data streams. In this implementation, the ring buffer writer is the CaptureTool (15). Referring to FIG. 15, the archiver function of the CaptureTool (15) acts as a ring buffer reader. The Search Service (7) also acts a ring buffer reader which allows for real time access to the index buffer (14), thereby enabling real time search. Ring buffers are well-known in the art and thus are not explained in further detail herein.

Scenario 2 describes a system that allows for real time search due to the fact that the capture process simultaneously indexes and encodes media, as compared to Scenario 1 where media is captured and encoded first for a period of time and then indexed afterwards. Scenario 1 introduces latencies that are proportional to the capture and encoding time plus the indexing time. For example, in Scenario 1, a one hour capture will take one hour to encode plus an additional three minutes to index using the exemplary Aurix phonetic indexing software, thereby creating a maximum latency of 63 minutes before any content within the one hour recording is available for searching. Scenario 2 improves upon this process by simultaneously indexing and encoding as media is captured which allows the search system to access to the index buffers while the index is being created. This allows the search system to provide (humanly imperceptible) real time search of media as it is broadcast.

### C. Summary of First Embodiment

To summarize, the first embodiment of the present invention provides a computer-implemented method of capturing and indexing audio streams in real time. Audio streams are captured in a processor from a plurality of audio sources in real time. The audio streams are then phonetically indexed into searchable audio data in real time. If a search query is entered into a search interface, indexed audio data is identified that matches the entered search query. The identified matches are present in the real time audio stream. The audio streams may include audio portions of an audio-visual stream, broadcasted audio streams, or on-air, terrestrial broadcasted audio streams.

To provide real time access to searchable audio data, the following process occurs:
1. The most recently captured audio streams are encoded and then temporarily stored in a media buffer. Simultaneously, the most recently captured audio streams are also indexed, such as phonetically, and the corresponding index files are temporarily stored in an index buffer. Preferably, the most recently captured audio streams in the media buffer exactly correspond to the most recently indexed audio streams in the index buffer. However, the scope of the present invention includes processes where there is not an exact correspondence.
2. An archiver periodically loads the contents of the media buffer and the index buffer into a permanent media storage and a permanent index storage, such as after a predetermined amount of time has passed, or after a predetermined amount of data bytes has accumulated in the media buffer or the index buffer. The exact time or data bytes between loads will depend upon many factors.
3. A search system and a media distribution system are allowed access to the permanent media storage and the permanent index storage, as well as to the media buffer and the index buffer. In this manner, real time access to searchable audio data can occur since any audio streams that just occurred will be immediately present in the media buffer and the index buffer, and thus will be searchable and retrievable therefrom.

“Real time” capturing and indexing, as described herein, provides the ability to conduct searches immediately after the audio content is spoken, that is, at the same rate as the spoken audio content with a humanly imperceptible latency.

II. Use of Time Information for Improving Media Search Results

### A. Scenario 1

A second embodiment of the present invention provides a scheme for improving media search results using time alignment criteria. More specifically, the scheme optimizes media search results that consolidates closely spaced search results based upon time proximity. The optimization scheme filters search results that occur within a specific time (t1) interval after an initial search hit. The optimization scheme is further enhanced by using a floating time window (t2) that continues to filter subsequent search hits that are closely spaced in time to each other. The scheme includes the following algorithmic steps:
a. Create a list of search results order by ascending time of the hit within the media file
b. Set pointers (p1, p2) to first search result
c. Copy (p1) result to output search result set (O).
d. Stop processing if p2 is the last search result
e. Set pointer (p2) to next search result
f. If time difference of (p2−p1)>t1 (filter time interval)

1. Set p1=p2,

2. Go to Step c
g. Set p1=p2
h. Go to step e.

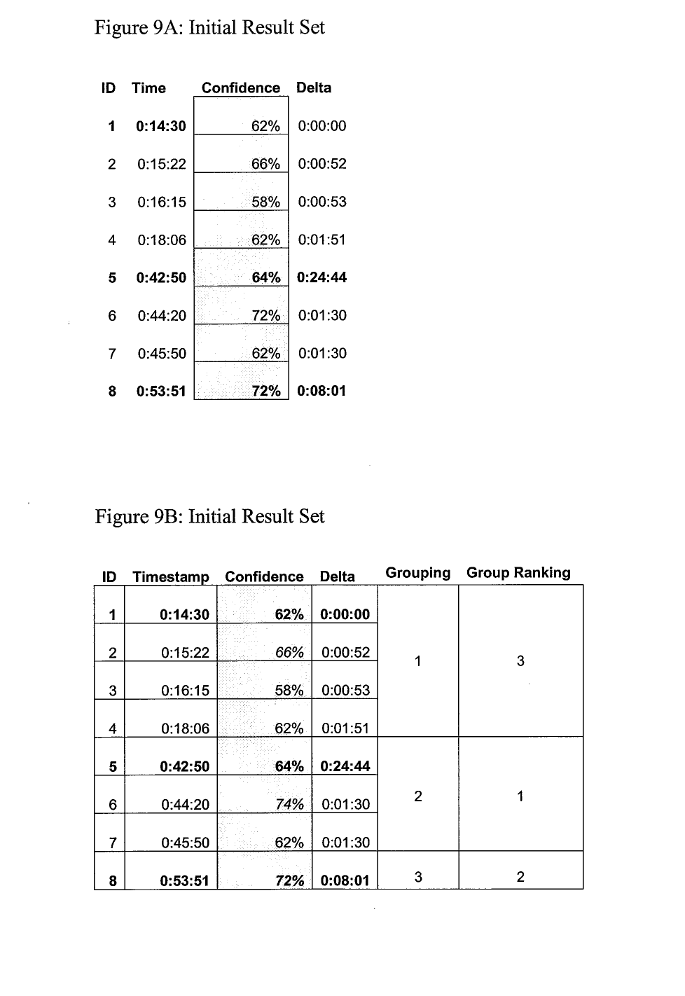

FIG. 9A shows a sample set of search results where each result returns a time and a confidence percentage. The “Delta” column represents the difference in time between the result row and the prior row.

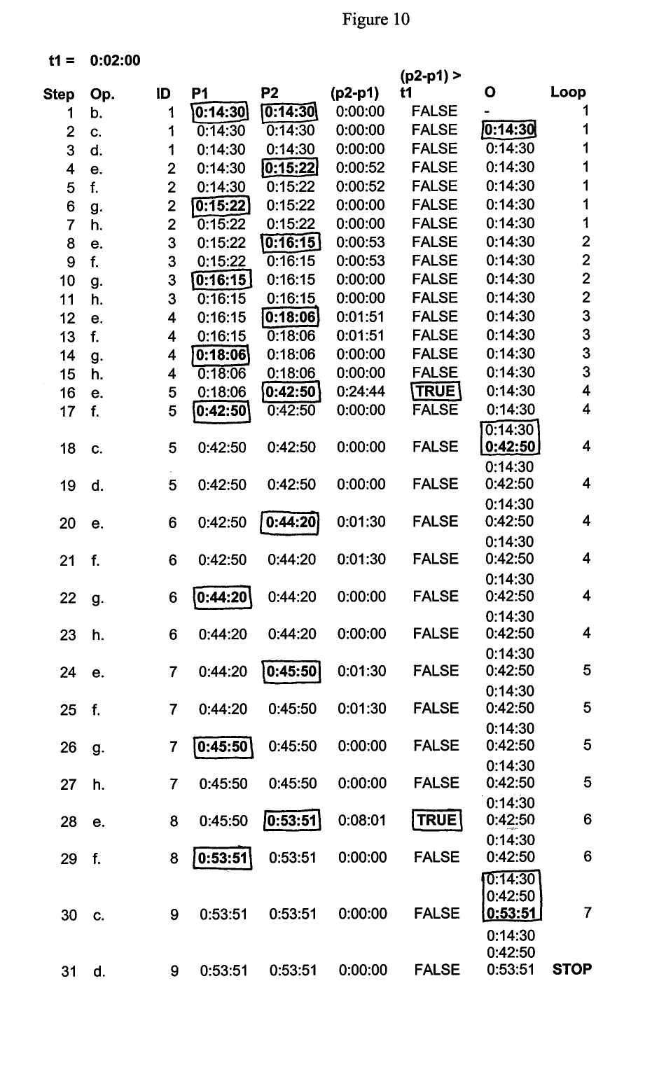

FIG. 10 shows an output search result set (O) that is created by following the steps set forth above. More specifically, FIG. 10 shows each step of the algorithm as it is executed in order to produce the final output shown in column (O). The variables of the algorithm are t1, p1, p2 and O, wherein:

t1 represents a sliding time window;

p1, p2 represent time positions from the set of results; and

O represents the output set of results.

Given an initial time window (t1) of 2 minutes, the algorithm executes 31 steps that reduce the initial set of 8 results to a set of 3 results. The 3 results represent ID numbers 1, 5 and 8 from the initial result set which are boldfaced in FIG. 10.

### B. Scenario 2

In an alternative scenario, pseudocode for a sample algorithm is as follows:

// the mixed set contains only valid search results
// pbest is the highest scored item
// mixed_set is an array containing the union of search results from
all sources, ordered by timestamp
// t1 is the predetermined timestamp (30 seconds to 4 minutes is
reasonable)
Size = length(mixed_set);
Current = 0;
P1 = mixedset[current];
While(current < size) {

Pbest = p1;
Current = current +1;
P2 = mixedset[current];
While(current < size && (p2 − p1) < t1) {

If(p2.score > pbest.score) pbest = p2;
P1 = p2;
Current = current +1;
P2 = mixedset[current];

}
Copy_to_outputset(pbest);
P1 = p2;

}
Order_outputset( ); // reorders the output based on score instead of
timestamp

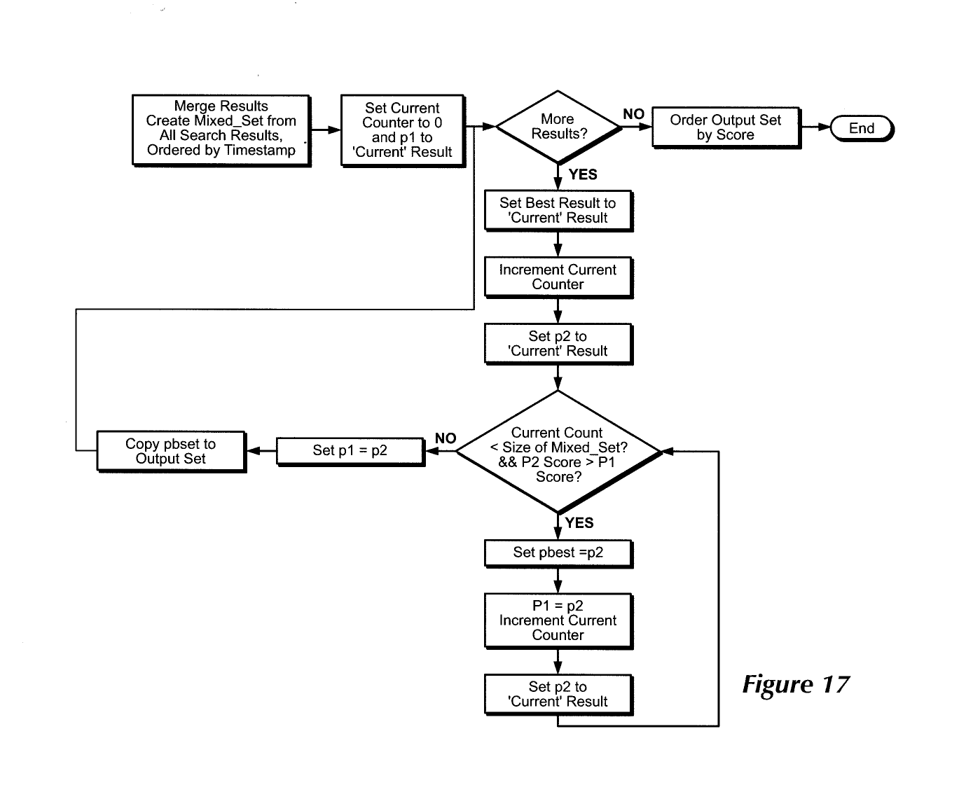

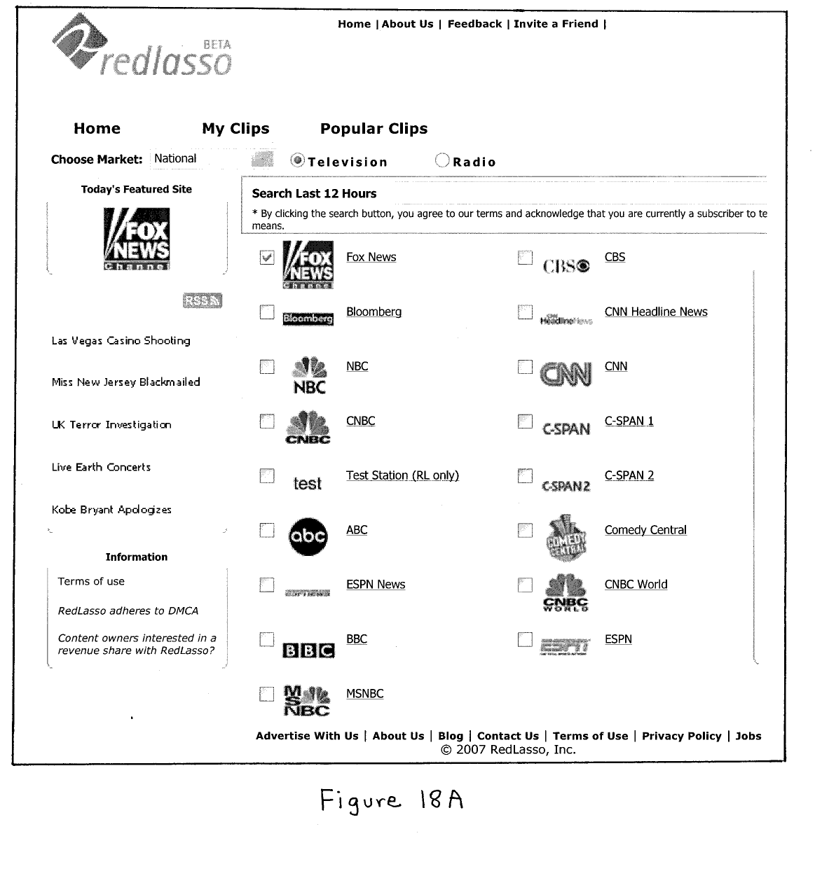

FIG. 17 shows a corresponding flowchart of this process.

FIG. 9B shows a sample set of search results where each result returns a time or time stamp and a confidence percentage. The “Delta” column represents the difference in time between the result row and the prior row. FIG. 9B also explicitly identifies the grouping of search result instances and the group rankings. In this example, the group rankings are based on the highest confidence result within a group, here ID numbers 2, 6 and 8 shown in italics.

### C. Summary of Second Embodiment

To summarize, search results are grouped as follows:
1. Identify instances of search results in an audio stream. Each instance will have a time stamp.
2. Identify a first grouping of the instances of the search results by the following subprocesses:

(i) Identify a first instance of the search result.

(ii) Identify a subsequent instance of the search result that occurs within a specific time interval after the first instance of the search result.

(iii) Identify another subsequent instance of the search result that occurs within the same specific time interval after the initial subsequent instance of the search result.

(iv) Repeat step (iii) for all subsequent instances of the search result.
3. Identify subsequent grouping of the instances of the search results by the following subprocesses:

(i) Identify another first instance of the search result that occurs more than the specific time interval after the last identified instance in step 2.

(ii) Repeat steps 2(ii)-2(iv).

The time stamps of the instances are used in determining whether or not subsequent instances occur within the specific time interval.

The specific time period is about 30 seconds to about four minutes. A range of 30 seconds to four minutes is determined as a reasonable time frame based on human speech patterns of under 160 words per minute. At 160 words per minute, logical groupings can be set to between 80 and 600 words. At the lower end of the threshold (80 words), word repetition clearly shows a contextual reference. For example, a news broadcaster may lead into a story with a phrase such as “at the white house today,” then shortly thereafter mention “our reporter at the white house has the story.” At the longer end of the range, grouping within four minute segments represents a contextual reference that demonstrates that the entire segment was semantically similar. Continuing the “white house” example, the reporter may continue to mention the white house (e.g., “white house aids,” “white house staff,” “at the white house”). The resultant search should only show the most relevant of all of these results, given the context.

Portions of the audio stream defined by the groupings may be replayed by starting the replay at the first instance of each of the groupings. Once it is determined that a group of individual results represent the same contextual search, playback of the segment can be started at the timestamp associated with the first occurrence in the group. Again, from the white house example, the playback would start with the first time the reporter said “white house.”

III. Media Playback Positioning

### A. Scenario 1

A third embodiment of the present invention provides a scheme for positioning media playback to a searched target position within a media file. More specifically, the scheme allows the playback of media search results at the specific position in time within the audio where the search term was found using a single click of a link or button on a web page. Given a set of media search results for a specific term, the user has the ability to click on a search result that will cause a media player to begin playing the streaming media content at a position that is within seconds of the utterance. The playback is further improved by starting the playback just prior to the utterance of the search term in order to preserve contextual flow of the media to the end user.

Consider the following example:

Given a webpage containing a Windows Media Player control and a link, the content source (mediaFile.wmv) can be loaded and positioned one minute into the clip where a search term was found. The PlayMedia( ) function starts the clip two seconds earlier by subtracting 2 from the hitTime passed to the function.

<html>
<head>
<Title>Sample Playback</Title>
<script type=”text/javascript”>
<!--

function PlayMedia(mediaURL, hitTime)
{

document. MediaPlayer1.url = mediaURL;
if (hitTime >=2)

document. MediaPlayer1.controls.currentposition =
hitTime − 2;

else

document. MediaPlayer1.controls.currentposition =
hitTime;

document. MediaPlayer1.controls.play( );

}

-->
</script>
</head>
<body>
<a href=”#” onClick=”PlayMedia(‘mediaFile.wmv’, 3600)”>Play</a>
</body>
</html>

### B. Scenario 2

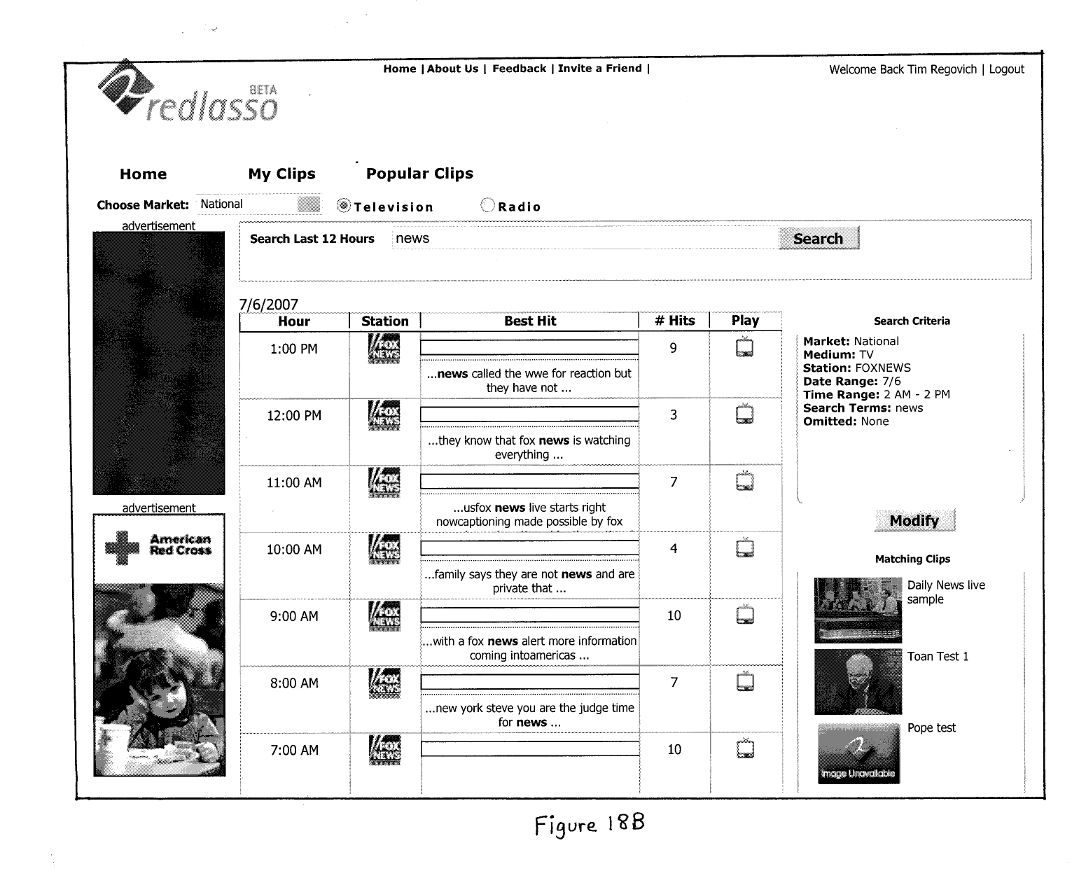

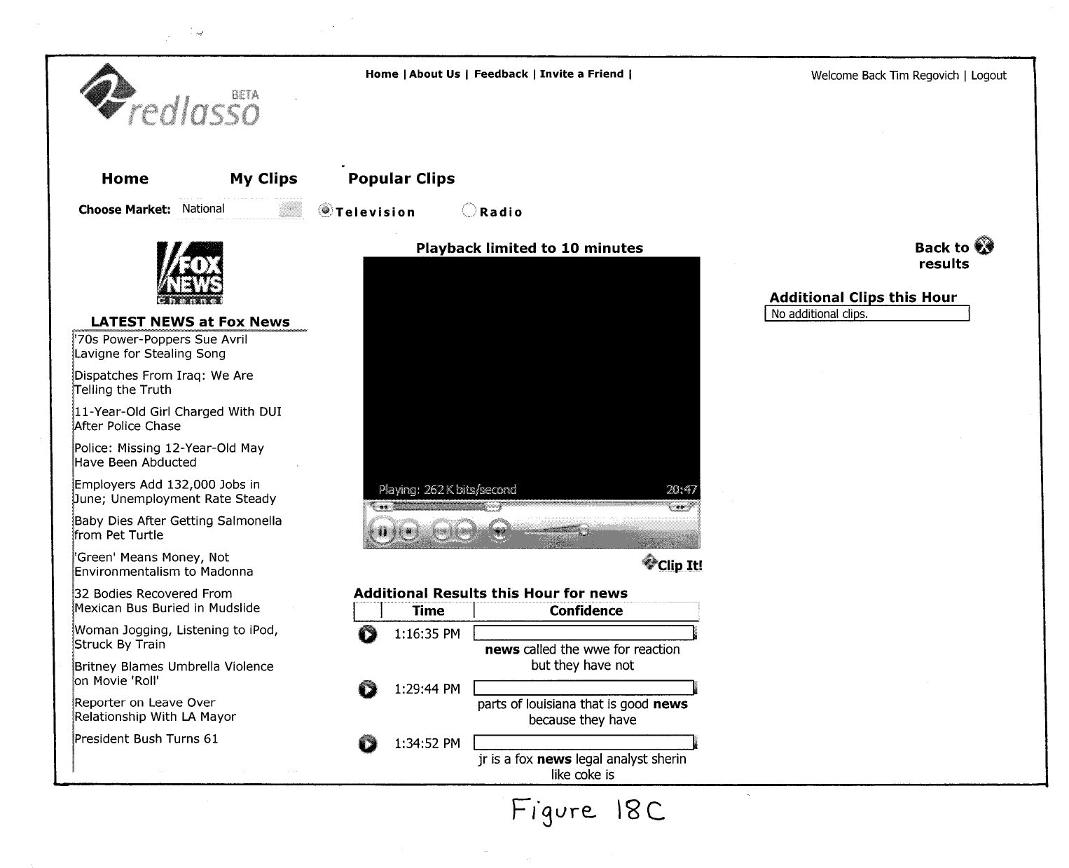

FIGS. 18A-18C show user interface display screens for implementing another scenario of this embodiment. In FIG. 18A, the user selects the different that are to be searched. FIG. 18B shows a subset of search results for the search term “news.” FIG. 18C shows the display screen after the user clicks on the first hit of the search results shown in FIG. 18B.

An example URI that provides the ability to start playback at a specific time is as follows:

http://beta.redlasso.com/Search/SearchResults.aspx?m=h3bst25.wma&t=995& . . .

A Uniform Resource Identifier is a formatted string that serves as an identifier for a resource, typically on the Internet. URIs are used in HTML to identify the anchors of hyperlinks. URIs in common practice include Uniform Resource Locators (URLs) and Relative URLs. See http://World Wide Web (www).freesoft.org/CIE/RFC/1866/7.htm for a discussion of URIs. In the example of FIGS. 18A-18C, the URI contains two parameters:

m: which has a value of “h3bst25.wma” and is a reference to the media to be played back.

t: which has a value of 995 and which represents the starting time offset in seconds (16 minutes, 35 seconds)

In this example, it is assumed that the media files are 1 hour in length and start at the beginning of each hour. The sample result shows a starting time of 1:16:35 which indicates that the first hit occurred at the 1 hour, 16 minutes, 35 seconds. The referenced file “h3bst25.wma” represents the 1 hour, and the “995” parameter represents the time offset in seconds within the hour.

The URI also references a web page:

http://beta.redlasso.com/Search/SearchResults.aspx

where “SearchResults.aspx” initiates a media player that loads the media referenced by m at a starting point of t in seconds relative to the starting position of the media file. The SearchResults.aspx web page could use the following Javascript code to start the player:

<script type=”text/javascript”>
<!--
function gup( name )
{

name = name.replace(/[\[ ]/,″\\\[″).replace(/[\]]/,″\\\]″);
var regexS = ″[\\?&]″+name+″=([\hat{ }&#]*)″;
var regex = new RegExp( regexS );
var results = regex.exec( window.location.href);
if( results = = null )

return ″″;

else

return results[1];

}
document.MediaPlayer1.url = gup(‘m’);
document.MediaPlayer1.controls.currentposition = gup(‘t’);
document.MediaPlayer1.controls.play( );
-->
</script>

In the example of FIGS. 18A-18C, the URI directly references the media file and the starting point within the media file. In an alternative embodiment, the URI may contain a reference key that is associated with the media file and the starting point. In this alternative embodiment, a lookup table is maintained that stores the reference keys and the media file and starting point associated with each of the reference keys. In this alternative embodiment, the example URI would be as follows:

http://beta.redlasso.com/Search/SearchResults.aspx?k=147kakewem . . . & . . .

wherein k represents the key.

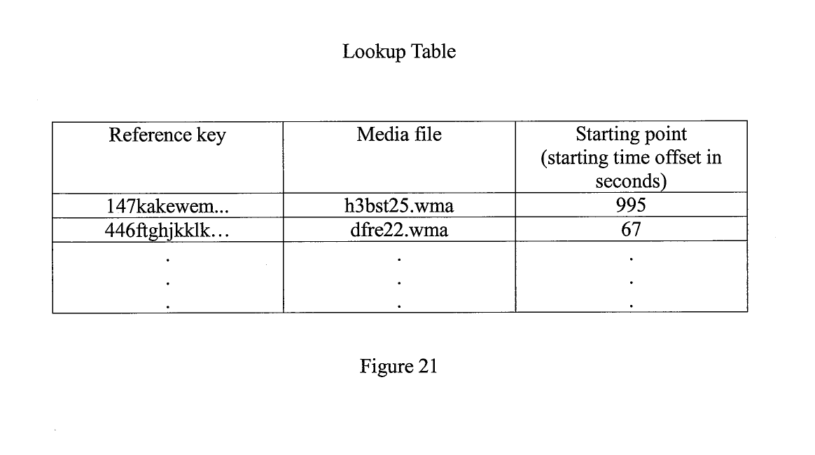

FIG. 21 shows a sample lookup table. In the first entry, the key referred to above functions as the index to the same media file and starting point as the example described above with respect to FIGS. 18A-18C.

### C. Summary of Third Embodiment

To summarize, the media playback positioning process allows a client machine that includes a media player to retrieve a portion of a media source via an electronic network. A client machine receives a Uniform Resource Identifier (URI) that identifies the media source and a starting point (i.e., playback location) within the media source that is based on an index of the media source. The client machine initiates a request for the media source identified by the URI. The request includes the starting point within the media source. The client machine receives the media source and plays the media source using the media player at the starting point within the media source.

The playing of the media source at the starting point occurs in response to only a single action being performed by the client machine. In the example of FIGS. 18A-18C, the single action is a selection of a displayed indicia, namely, a click of link of a resource identified by the URI associated with the media source. More specifically, the single action is clicking a mouse button when a cursor is positioned over a predefined area of information displayed on a browser that is related to the media source identified by the URI.

In alternative embodiments, the single action may be uttering a sound generated by a user and detected by the client machine, a selection made using a television remote control if the client machine works in conjunction with the television display, a depression of a key on a key pad associated with the client machine, a selection made using a pointing device associated with the client machine, or other similar types of single actions.

IV. Use of Category Taxonomy to Improve Search Result Relevance

A fourth embodiment of the present invention provides a scheme that incorporates category taxonomies of search terms that are used to improve the relevance of search results. This scheme may be used for text-based content or audio-based content.

A category taxonomy consists of a set of search terms that closely correlate to a given categorization. A given set of content is processed using each of the search terms within a specific category taxonomy. A relevance score is then calculated based on the number of search terms that are found within the content being searched.

To illustrate this scheme, consider an example where a search term, “Eagles” is requested. “Eagles” has many potential meanings (e.g., a bird, a golf term, a football team). An optional search field may be provided to allow a user to enter a taxonomy. Thus, the search input would appear as follows:

Search term(s): eagles

Taxonomy: football

Each hit that is located based on the search term is then given a relevance score based on the taxonomy for “football.” The relevance scores are then used to determine which search hits to display to the user, and to determine their ranking.

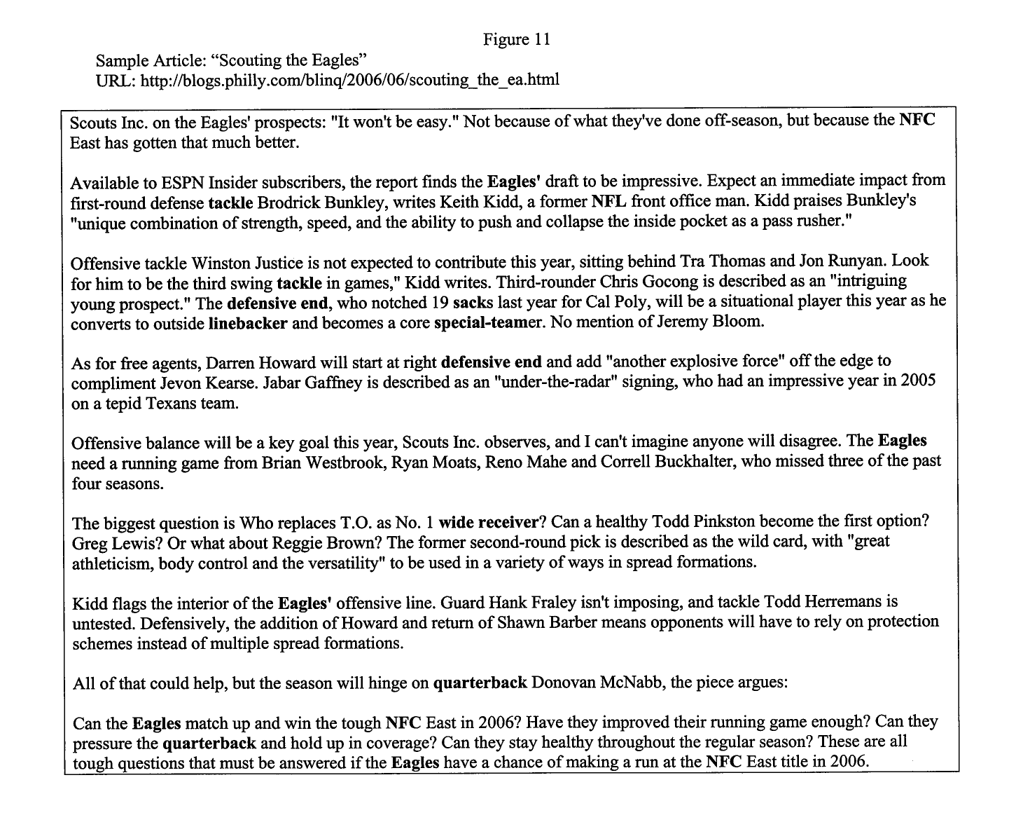

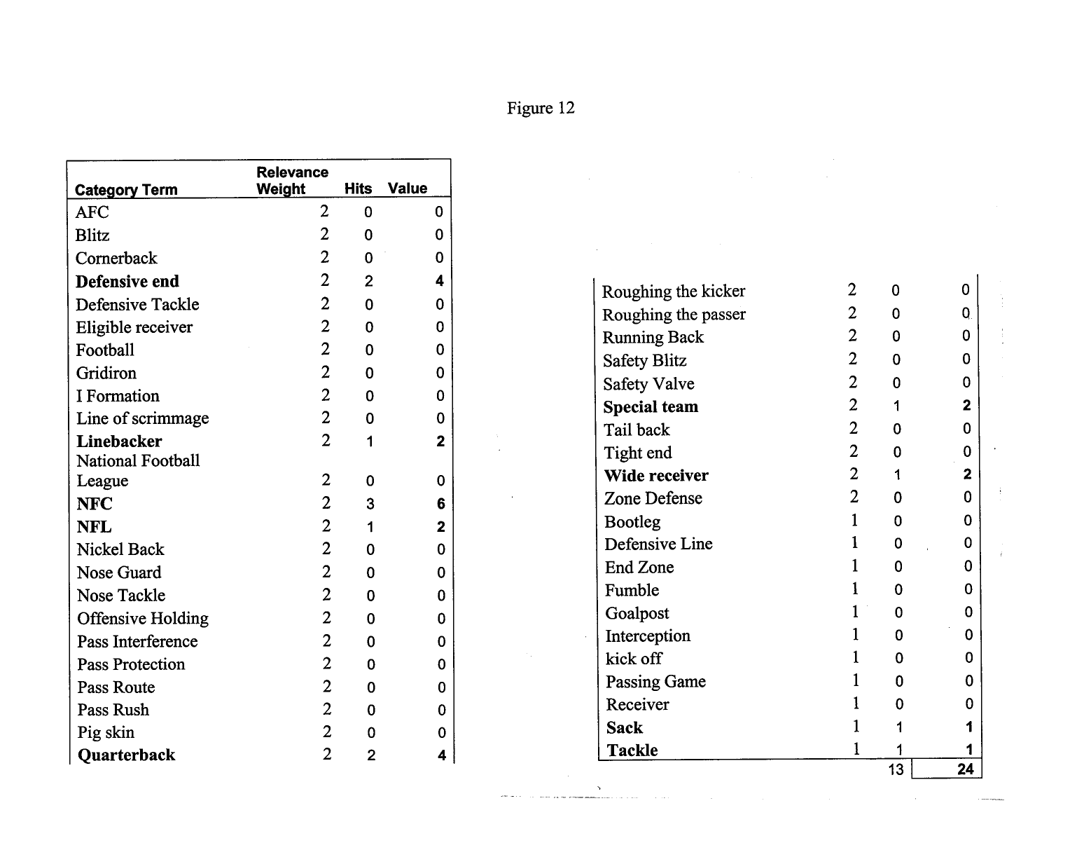

FIG. 11 shows a sample article that was located based on the search term, “Eagles.” FIG. 12 shows a sample taxonomy for “football” and shows how the sample article would be rated based on the football taxonomy. A summary of the taxonomy analysis is as follows:

Football Taxonomy:
Quarterback (2)
Wide receiver (1)
Defensive end (2)
Special team (1)
NFL (1)
NFC (3)
Tackle (1)
Sack (1)
Linebacker (1)
   Here, the relevance score is “24” which would be a relatively high relevance score. As discussed above, this relevance score would be compared to the relevance score for other search term hits to determine which search hits to display to the user, and to determine their ranking. For example, an article entitled “Bald eagles removed from endangered species list” (not shown) would not likely include any of the words or phrases in the football taxonomy, and thus would likely have a relevance score of “0.”

In one preferred embodiment, the taxonomy is selected from a drop-down menu that lists a plurality of taxonomies (e.g., politics, biology).

To summarize, the relevance of different sets of content to a search query are ranked in the following manner:
1. A plurality of category taxonomies are stored. Each category taxonomy is a set of terms that closely correlate to a given categorization. For example, FIG. 12 shows the category taxonomy for football. The terms may be individual words or phrases.
2. A search query is received by a search engine. The search query includes not only the search terms, but a category taxonomy identifier (e.g., football).
3. Terms in a plurality of different sets of content are identified that belong to the identified category taxonomy. For example, the bolded terms in FIG. 11 are identified because they are in the football category taxonomy shown in FIG. 12.
4. The relevance of the different sets of content are ranked based at least in part on the number of terms identified in each set of content. The article shown in FIG. 11 received a relevance score of “24,” whereas the bald eagle article likely would have received a relevance score of “0.” The relevance terms may be further defined by a relevance weight for the particular category taxonomy. That is, certain terms that are more likely to be associated with a particular category taxonomy than other terms will receive a greater relevance weight.

Results are then reported back to the search requester in the same manner as conventional search engines, wherein the most relevant results are reported first.

The sets of content may be blocks of related text, such as website pages or articles, or blocks of transcribed audio, such as radio or TV programs.

Furthermore, each term in a set of terms may have a defined relevance weight. During the ranking process, the relevance of an identified search term is then weighted based on the relevance weight.

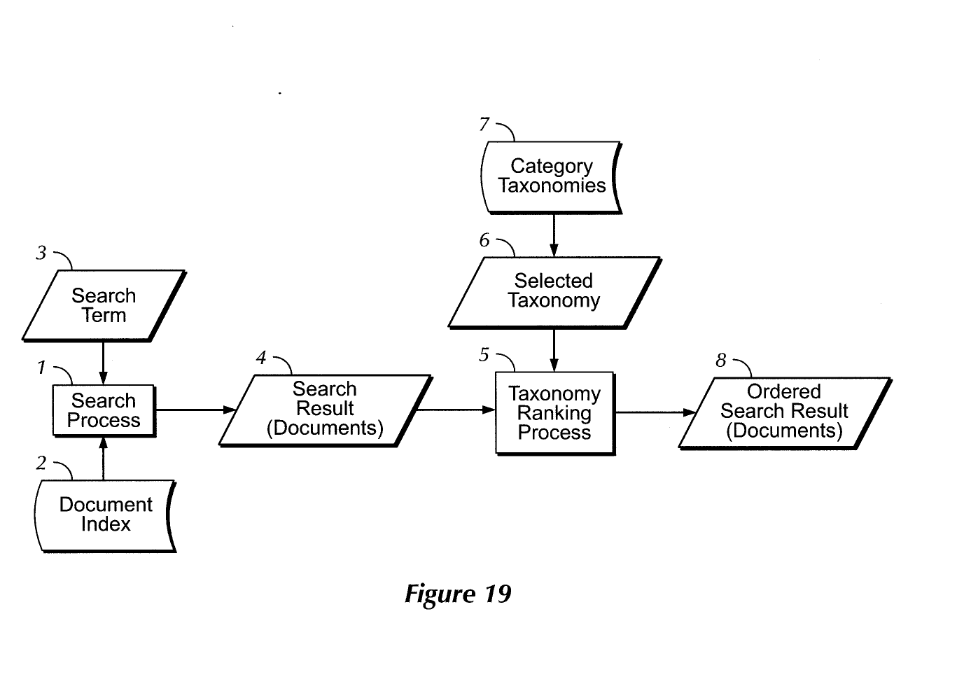

FIG. 19 is a flowchart of a search algorithm that uses category taxonomies to rank search results. The algorithm initiates a ‘Search process’ (1) that searches a ‘document index’ (2) for documents related to the ‘search term’ (3). The ‘Search Process’ (1) outputs an initial set of ‘Search Results’ (4) that are passed as an input to the ‘Taxonomy Ranking Process’ (5). The Taxonomy Ranking process (5) parses each search result document using a ‘selected taxonomy’ (6) selected from a plurality of ‘Category Taxonomies’ (7). The ‘selected taxonomy’ (6) represents a list of search terms related to a given taxonomy. The Taxonomy Ranking process (5) searches each search result document using the list of search terms from the selected taxonomy. The Taxonomy Ranking process (5) then accumulates a weighting to each search result document for each search term found. Finally, the Taxonomy Ranking process (5) orders the Search Result documents (8) based from a weighting of highest to lowest.

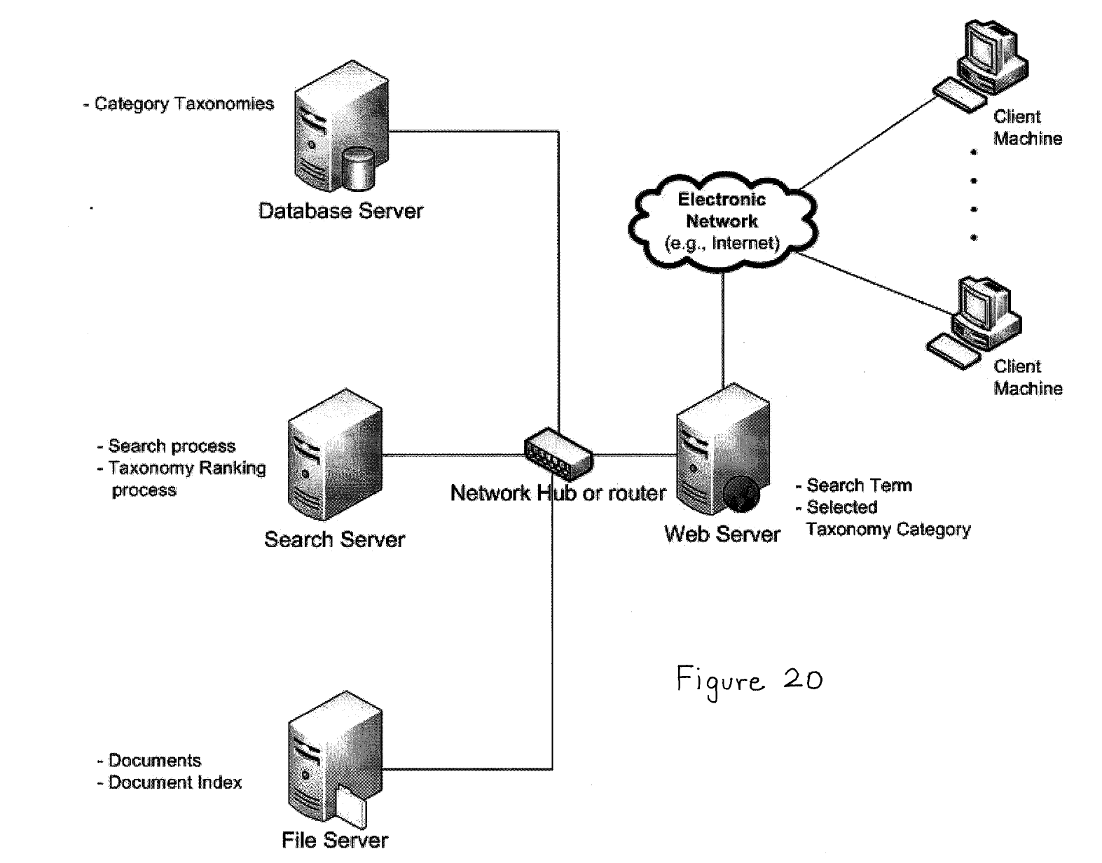

FIG. 20 is a self-explanatory schematic block diagram of the hardware elements for implementing a search process using category taxonomy as shown in FIG. 19.

The disclosed embodiments of the present invention provide for the ability to capture audio content in real time, index the audio content in real time, and allow for searching of the audio in real time. The audio content is the actual spoken audio, not merely a transcription of the spoken audio, such as provided by closed-captioning. However, closed-caption text can be used to enhance the performance of the search engine.

One preferred embodiment of the present invention is implemented via the source code in the accompanying Appendix. However, the scope of the present invention is not limited to this particular implementation of the invention.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

While the present invention has been particularly shown and described with reference to one preferred embodiment thereof it will be understood by those skilled in the art that various alterations in form and detail may be made therein without departing from the spirit and scope of the present invention.

What is claimed is:

1. A computer-implemented method of capturing and indexing audio streams in real time, the method comprising:
(a) capturing and simultaneously indexing audio streams from a plurality of audio sources in real time; and
(b) simultaneously storing in real time
(i) the captured audio streams from the plurality of audio sources, and
(ii) index data of the captured audio streams from the plurality of audio sources.

2. The method of claim 1 wherein step (b) further comprises:
(i) temporarily storing the most recently captured audio streams,
(ii) temporarily storing index data of the most recently captured audio streams,
(iii) permanently storing the captured audio streams,
(iv) permanently storing the index data of the captured audio streams, and
(v) periodically loading the temporarily stored audio streams into permanently stored audio streams and periodically loading the temporarily stored index data into the permanently stored index data.

3. The method of claim 2 wherein step (b)(v) occurs after a predetermined amount of time has passed.

4. The method of claim 2 wherein step (b)(v) occurs after a predetermined amount of data bytes has accumulated in the media buffer or the index buffer.

5. The method of claim 2 further comprising:
(c) providing a search and media distribution system connected to the temporarily stored audio streams and the temporarily stored index data for allowing real time search and retrieval access to the captured audio streams.

6. The method of claim 2 wherein the index data is phonetic index data.

7. The method of claim 2 wherein the most recently captured audio streams exactly correspond to the most recently indexed audio streams.

8. The method of claim 1 wherein the audio streams include audio portions of an audio-visual stream.

9. The method of claim 1 wherein the audio streams include broadcasted audio streams.

10. The method of claim 1 wherein the audio streams include on-air, terrestrial broadcasted audio streams.

11. A computer-implemented apparatus for capturing and indexing audio streams in real time, the apparatus comprising:
(a) an audio capture system that captures and simultaneously indexes audio streams from a plurality of audio sources in real time; and
(b) a media storage and index storage system that simultaneously stores in real time
(i) the captured audio streams from the plurality of audio sources, and
(ii) index data of the captured audio streams from the plurality of audio sources.

12. The apparatus of claim 11 wherein the media storage and index system includes:
(i) a media buffer that temporarily stores the most recently captured audio streams,
(ii) an index buffer that temporarily stores index data of the most recently captured audio streams,
(iii) a media store that permanently stores the captured audio streams,
(iv) an index store that permanently stores the index data of the captured audio streams, and
(v) an archiver that periodically loads contents of the media buffer and the index buffer into the media store and the index store.

13. The apparatus of claim 12 further comprising:
(c) a search and media distribution system connected to the media buffer and the index buffer, thereby allowing for real time search and retrieval access to the captured audio streams.

14. The apparatus of claim 12 wherein the most recently captured audio streams in the media buffer exactly correspond to the most recently indexed audio streams in the index buffer.

15. The apparatus of claim 12 wherein the index data is phonetic index data.

16. The apparatus of claim 11 wherein the audio streams include audio portions of an audio-visual stream.

17. The apparatus of claim 11 wherein the audio streams include broadcasted audio streams.

18. The apparatus of claim 11 wherein the audio streams include on-air, terrestrial broadcasted audio streams.

19. A computer-implemented method of grouping search results by:
(a) identifying instances of search results in an audio stream, each instance having a time stamp;
(b) identifying a first grouping of the instances of the search results by:
(i) identifying a first instance of the search result,
(ii) identifying a subsequent instance of the search result that occurs within a specific time interval after the first instance of the search result,
(iii) identifying another subsequent instance of the search result that occurs within the same specific time interval after the initial subsequent instance of the search result,
(iv) repeating step (iii) for all subsequent instances of the search result; and
(c) identifying subsequent grouping of the instances of the search results by:
(i) identifying another first instance of the search result that occurs more than the specific time interval after the last identified instance in step (b), and
(ii) repeating steps (b)(ii)-(b)(iv),
wherein the time stamps of the instances are used in determining whether or not subsequent instances occur within the specific time interval.

20. The method of claim 19 wherein the audio stream includes audio portions of an audio-visual stream.

21. The method of claim 19 wherein the specific time period is about 30 seconds to about four minutes.

22. The method of claim 19 further comprising:
(d) replaying portions of the audio stream defined by the groupings by starting the replay at the first instance of each of the groupings.

23. The method of claim 19 wherein a plurality of groupings of instances of search results are identified, the method further comprising:
(d) ranking the plurality of groupings based on the relevance of the instances of the search results.

24. An actionable Uniform Resource Identifier (URI) comprising:
(a) a media source; and
(b) a starting point within the media source that is based on an index of the media source.

25. The URI of claim 24 wherein the media source is an audio or audio-visual file.

26. The URI of claim 24 wherein the index to the starting point within the media source is a time offset from a predefined starting time in the media source.

27. The URI of claim 24 wherein the starting point within the media source is a predetermined amount of time prior to a point of interest within the media source.

28. The URI of claim 24 wherein the index to the starting point within the media source is a byte position within the media source.

29. The URI of claim 24 wherein the starting point within the media source is a predetermined number of bytes prior to a point of interest within the media source.

30. An actionable Uniform Resource Identifier (URI) comprising a key, the key being associated with:
(a) a media source; and
(b) a starting point within the media source that is based on an index of the media source.

31. The URI of claim 30 wherein the media source is an audio or audio-visual file.

32. The URI of claim 30 wherein the index to the starting point within the media source is a time offset from a predefined starting time in the media source.

33. The URI of claim 30 wherein the starting point within the media source is a predetermined amount of time prior to a point of interest within the media source.

34. The URI of claim 30 wherein the index to the starting point within the media source is a byte position within the media source.

35. The URI of claim 30 wherein the starting point within the media source is a predetermined number of bytes prior to a point of interest within the media source.

36. A method of assembling an actionable Uniform Resource Identifier, the method comprising:
(a) identifying a media source of interest and a location in the media source of interest; and
(b) assembling a URI that identifies:
(i) the media source, and
(ii) a starting point within the media source that is based on an index of the media source,
wherein the starting point within the media source is associated with the location within the media source of interest.

37. A method of assembling an actionable Uniform Resource Identifier, the method comprising:
(a) identifying a media source of interest and a location in the media source of interest; and
(b) assembling a URI that identifies a key associated with:
(i) the media source, and
(ii) a starting point within the media source that is based on an index of the media source,
wherein the starting point within the media source is associated with the location within the media source of interest.

38. A computer-implemented method for allowing a client machine that includes a media player to retrieve a portion of a media source, the method comprising:
(a) a client machine receiving a Uniform Resource Identifier (URI) that identifies:
(i) the media source, and
(ii) a starting point within the media source that is based on an index of the media source; and
(b) the client machine initiating a request for the media source identified by the URI, the request including the starting point within the media source; and
(c) the client machine receiving the media source and playing the media source with the media player at the starting point within the media source.

39. The method of claim 38 wherein step (c) occurs in response to only a single action being performed by the client machine.

40. The method of claim 39 wherein the single action is a click of link of a resource identified by the URI associated with the media source.

41. The method of claim 39 wherein the single action is clicking a mouse button when a cursor is positioned over a predefined area of displayed information that is related to the media source identified by the URI.

42. The method of claim 39 wherein the single action is selection of a displayed indication.

43. The method of claim 39 wherein the client machine includes a browser for use in performing steps (a)-(c).

44. The method of claim 38 wherein the client machine initiates requests and receives the media source from a remote location via an electronic network.

45. A computer-implemented method for allowing a client machine that includes a media player to retrieve a portion of a media source, the method comprising:
(a) a client machine receiving a Uniform Resource Identifier (URI) that identifies a key associated with:
(i) the media source, and
(ii) a starting point within the media source that is based on an index of the media source; and
(b) the client machine initiating a request for the media source identified by the URI, the request including the key associated with the media source and the starting point within the media source; and
(c) the client machine receiving the media source and playing the media source with the media player at the starting point within the media source.

46. The method of claim 45 wherein step (c) occurs in response to only a single action being performed by the client machine.

47. The method of claim 46 wherein the single action is a click of link of a resource identified by the URI associated with the media source.

48. The method of claim 46 wherein the single action is clicking a mouse button when a cursor is positioned over a predefined area of displayed information that is related to the media source identified by the URI.

49. The method of claim 46 wherein the single action is selection of a displayed indication.

50. The method of claim 46 wherein the client machine includes a browser for use in performing steps (a)-(c).

51. The method of claim 45 wherein the client machine initiates requests and receives the media source from a remote location via an electronic network.

52. A computer-implemented method of ranking the relevance of different sets of content to a search query, the method comprising:
(a) storing a plurality of category taxonomies, each category taxonomy being a set of terms that closely correlate to a given categorization;
(b) receiving a search query and a category taxonomy identifier;
(c) identifying terms in a plurality of different sets of content that belong to the identified category taxonomy; and
(d) ranking the relevance of the different sets of content based at least in part on the number of terms identified in each set of content.

53. The method of claim 52 wherein the terms are words and phrases.

54. The method of claim 52 wherein the sets of content are blocks of related text.

55. The method of claim 52 wherein the sets of content are blocks of transcribed audio.

56. The method of claim 52 wherein each term in a set of terms has a defined relevance weight, and step (d) further comprises weighting the relevance of an identified term based on the relevance weight during the ranking.

57. The method of claim 52 further comprising:
(e) responding to the search query by electronically communicating a plurality of links to the different sets of content in ranked order of relevance to the requester of the search query.
